(19) United States
(12) Patent Application Publication
(10) Pub. No.: US 2013/0127333 A1
(43) Pub. Date: May 23, 2013

(54) OXYNITRIDE LUMINESCENT MATERIAL, PREPARATION METHOD THEREOF AND ILLUMINATION LIGHT SOURCE MADE FROM SUCH MATERIAL

(71) Applicants: Xiaoqing Jia, Beijing (CN); Haisong Wang, Beijing (CN); Peng Bao, Beijing (CN)

(72) Inventors: Xiaoqing Jia, Beijing (CN); Haisong Wang, Beijing (CN); Peng Bao, Beijing (CN)

(73) Assignee: BEIJING YUJI SCIENCE AND TECHNOLOGY CO. LTD, Beijing (CN)

(21) Appl. No.: 13/813,400

(22) PCT Filed: Feb. 23, 2011
(86) PCT No.: PCT/CN2011/071210

§ 371 Date: Jan. 30, 2013

(30) Foreign Application Priority Data
Dec. 28, 2010 (CN) 20101061121.5

(51) Int. Cl. C09K 11/77; H05B 33/14

(52) U.S. Cl. CPC C09K 11/7731; C09K 11/7718; H05B 33/14
USPC 313/503; 252/301.4 F; 252/301.4 R

(57) ABSTRACT

A nitrogen oxide luminescence material, with chemical formula: M_{1-y}X₄₋ₓZ₁₊ₓOₓN₇₋ₓx: R_{y}, in which M represents one or several alkali, alkaline earth, rare earth and transition metals. X represents Si with one or several of Si, Ge, B and Al. Z represents Al with one or several of Al, Ga, In. R represents one or several of luminescence center elements Eu, Ce, Tb, Yb, Sm, Pr and Dy. In the formula, 0≦x<0.5, 0<y<1.0. The luminescence material can be excited by ultraviolett, near ultraviolet or blue light, and emits yellow or red light with wavelength between 500-750 nm. With the ultraviolet, near ultraviolet or blue lights, and other types of luminescence materials, such as green fluorescent powder, a new white LED can be obtained. The luminescence material has a wider excitation spectrum range, and is efficient and stable. Preparation is simple, easy to mass-produce and pollution-free.

### THE TECHNICAL FIELD BELONGS

The present invention relates to the field of semi-conductor, particularly to a kind of Oxynitride compounds as well as the preparation method and illuminating source by using it.

### TECHNICAL BACKGROUND

GaN based Light-Emitting Diode as 21 st century's new-type light-emitting devices for solid state lighting shows a series of advantages just as following: small, electricity-saving, with long service life, free of the polluted-environment Hydrargyrum, efficient and low maintenance and with which GaN based Light-Emitting Diode can be widely used in a variety of lighting facility which including interior illumination, traffic lights, automobile tail light/headlamp, outdoor large screen, display and advertising screen. The trend that replacing currently used all kinds of light bulbs and fluorescent lamps had already emerged. And the new type of green lighting source will have become the new generation of illuminating system, which will have introduced a profound effect on energy-conserving, environment-protection and the improvement of life quality. The fabrication techniques of White LED are as following: the three-monochrome blue-green-and-red LED combination, blue LED mixed with yellow fluorescent powder, ultraviolet LED mixed with red-green-and-blue fluorescent powder. However, there is little inorganic luminescent material which can be excited by blue LED. The mostly used fluorescent materials Yttrium Aluminitum Garnet (YAG) and Ce so far combined with blue LED on basis of the principle of complementary color, white light reached. However, the photochromism of the light provided by YAG closes to yellow-green, high-color-temperature cool coloured white light can only be reached with color rendering index low. Then, green, yellow or red fluorescent powder should be considered for different color-temperature white light ranged from cool colors to warm colors, and also for better color rendering index.

The currently used green fluorescent powder, which can be excited by blue light (420-480 nm), blended mostly with divalent Europium Sulfide, such as (Ca, Sr, Ba)GaS₄: Eu²⁺. However, with poor chemical resistance and thermal stability, Sulfide fluorescent powder is phone to react with the moisture from the air, the heat after decomposition, and with some exhaust fumes released in manufacture procedure which polluted the air. Recently, the using nitrogen compounds, which composed by SiN₄ as the basic unit, as the host material for the fluorescent powder received great attention. On the basis of the strong covalent bond and the large crystal field splitting, when mixed with lanthanon such as divalent Europium, these compounds can excite luminescence under the longer wavelengths, such as yellow, orange or red. By selecting host material and considering on the crystal or ligand field, the surrounding environment of luminescence center atom can be changed, thereby to adjust the luminescent performance and develop new type of fluorescent powder. This invention reports a new type of Nitrogen Oxide fluorescent powder which can be excited luminescence yellow or red by ultraviolet light or blue light, and reports simultaneously the preparation of white LED light source by using Nitrogen Oxide fluorescent powder coordinating with blue LED.

### THE CONTENTS OF THIS INVENTION

The present invention aiming at the above-mentioned areas of problems offers a Nitrogen Oxide luminescence material, with stable chemical properties and excellent luminescent performance, can be excited luminescence yellow or red by ultraviolet or blue light, and with excitation wavelength between 200-500 nm, emission wavelength between 500-700 nm.

In another aspect of this invention, the method of the preparation for the luminescence material was introduced, which is simple, handled easily, easy to mass production, pollution-free and with low costs. By using this method, high illumination-intensity, even granular and with particle size smaller than 10 nm micronized fluorescent powder can be reached.

The present invention also aimed at offering a white LED light source by using the luminescence material.

A type of Nitrogen Oxide luminescence material, with chemical formula: M_{1-y}A₄₋ₓZ₁₊ₓOₓN₇₋ₓ: R_{y}, M in the formula is for one or several of alkali metal, alkaline earth metal, rare earth metal and transition metals. A in the formula is for Si together with one or several of Si, Ge, B and Al. Z is for Al together with one or several of Al, Ga, In. R is for one or several of luminescence center elements Eu, Ce, Tb, Yb, Sm, Pr and Dy. And 0≦x<0.5, 0<y<1.0.

Preferably, M is for one or several of Li, Mg, Ca, Sr, Ba, Bi, Mn, Zn, La, Gd, Lu and Y.

Optimally, M is for Sr together with one or several of Li, Mg, Ca, Zn, Sr, Ba, Bi and Y.

The content of Sr is more than 0.8, and A is for Si, Z is for Al, R is for Eu, Ce or both.

Preferably, 0≦x≦0.15, 0<y≦0.1.

Optimally, 0≦x≦0.1, 0.05≦y≦0.1.

The preparation procedure of the above mentioned Nitrogen Oxide luminescent material is as following:
(1) By milling, we mixed M-containing Oxides, Nitrides, Nitrates or Carbonates, with A-containing Nitrides or Oxides, and Z-containing Nitrides or Oxides, and R-containing Nitrides, Oxides or Nitrates.
(2) Under inert gas protection the mixture reached from step above through high-temperature roasting by using gas pressure sintering or solid reaction process, some roasted product reached.
(3) The roasted product reached from step (2) was then through grinding, impurity removal, heating and sizing, and then Nitrogen Oxide luminescence material reached.

Electively, inert gas introduced in gas pressure sintering step is Nitrogen, with the pressure between 1-200 atmospheres.

Electively, inert gas introduced in solid reaction process is a mixture of room-pressure Nitrogen and hydrogen, with a volume ratio 95:5, or 90:10, or 85:15, or 80:20. And the gas flow rate is between 0.1-3 L/min.

Electively, the temperature from high-temperature roasting step is between 1200-1800° C., and roasting for 0.5-30 hours at a time or by several times.

The temperature for Carbon thermal reduction nitridation step, a type of high-temperature roasting methods, is between 1200-1600° C., and roasting for 0.5-30 hours.

Electively, a reaction flux was added in step (1), which is M-containing halide, or Boric acid, or both.

Electively, additive amount of the reaction flux is 0.01-10% of the total amount of raw materials.

Electively, the impurity removal step includes acid pickling or rinsing by water.

The white LED light source characterized in the ultraviolet or near ultraviolet LED-containing, and above mentioned Nitrogen Oxide luminescence material-containing.

The white LED light or display source characterized in blue LED-containing, and above mentioned Nitrogen Oxide luminescence material-containing.

The technical effect of the present invention is as following:

The present Nitrogen Oxide luminescence material can be excited under 200-500 nm, then emits yellow or red light with wavelength between 500-750 nm, especially above 560 nm.

In the synthetic method adopted by the present invention, the raw material can be M-metal nitride, -Oxides, -carbonates or -nitrates. All salts, which under high-temperature roasting can be decomposed into metal oxide, can be adopted. Under this rule, the scope of selection of the raw material can broaden, and the synthesis cost can be lowered. With more stable salts introduced, no special treatment step is needed for the raw material during the synthesis process, which makes the reaction easy control and be achieved mass production. M-metal nitrides, -oxides, -carbonates, -nitrates, mixed with A-oxides, -nitrides, and Y-oxides, -nitrides, and R-nitrides, -oxides, through high-temperature roasting, reached the present luminescence material. In the process of high-temperature roasting, inert gas was introduced for the following purposes: (1) to protect some nitride material and reaction products from decomposing at high temperature, (2) and to perform as reductive circumstance. N₂ or the mixture of N₂ and H₂ is commonly introduced as inert gas, under high atmospheric pressure or room pressure. Before high-temperature roasting, during mixed and grinding step, solvent Ethanol or n-Hexane can be used for mixed more evenly. Also, before high-temperature roasting, halide of fluxing agent M or boric acid can be adopted. And during post-treatment reactive impurities can be removed. On the basis of above mentioned materials, after high-temperature roasting, normally are oxides which containing element M, and/or A, and/or Y, and/or R. All these impurities, besides part of which volatilized, by using acid pickling or rinsing by water step, can be removed.

Nitrogen Oxide luminescent material synthesized by the method of the present invention can be excited by the light wavelength between 200-500 nm, and emits yellow or red light wavelength between 500-700 nm, in light of which Nitrogen Oxide luminescent material, with other luminescent materials, such as red luminescent material, can be coated at blue LED chip to create new type of white LED. And also with other luminescent materials, such as blue or green luminescent material, coated at ultraviolet and near ultraviolet LED chip to create new type of white LED, and the efficiency of energy transformation is high. And with blue LED, ultraviolet or near ultraviolet LED, or mixed with other luminescent materials to create the colorful LED.

At present, the yellow fluorescent powder for the preparation of white LED is commonly the YAG system which mixed with Ce3+. And characterized in broader emission peak, high brightness and mainly used for high-color-temperature white LED, color temperature is higher than 5000 k. YAG-system fluorescent powder is a bit weaker at temperature characteristic, and some combination with high luminescence decay. The Nitrogen Oxide luminescent material synthesized by the method of the present invention, with completely different chemical structural formula and the crystal structure from YAG-system, is an entirely new group of luminescent materials. The compound mixed with Ce3+, the yellow luminescent material of which the emission wavelength longer than that of YAG can be reached, and which can be used to produce low-color-temperature white LED, the temperature is lower than 5000 k, or by some adjustment of the combination to produce yellow luminescent material of which the emission wavelength is close to that of YAG, which can be used for the preparation of high-color-temperature white LED. And the compound mixed with Eu2+, the emission wavelength of which locates at the red region, is a kind of red luminescent material, which by mixing with other green fluorescent powder can be used for the preparation of high-color rendering white LED. Besides, due to containing the elements Nitrogen, the compound synthesized by the method of the present invention has the strong covalent chemical bonds and the three-dimensional network structure composed of SiN4 tetrahedron units, and then therefore has the better temperature characteristics. By adjusting the ratio of element Nitrogen to Oxygen, a certain range of solid solution formed, then the emission wavelength can be adjusted, and accordingly bringing a wider range of applications. The present preparation procedure is simple and handled easily, easy to mass production, and by partially replacing elements, wavelength tunable and improved luminous intensity achieved. And the present method of the preparation for the luminescence material is simple, handled easily, easy to mass production, pollution-free and with low costs.

Characterized in as following:
(1) The luminescence material synthesized by using the presented method is a Nitrogen oxide with stable performance and good temperature characteristics.
(2) With broader excitation spectrum range between 200-500 nm, the luminescence material shows a better activating effect.
(3) And the present method of the preparation for the luminescence material is simple and practical, pollution-free, easy to mass production, and handled easily.
(4) The white LED by using the present method has high color rendering index, high luminous efficiency, and wide color temperature range.

### DESCRIPTION OF FIGURES

FIG. 1 shows emission spectrum and excitation spectrum of embodiment 1, ordinates in the figure show luminous intensity, and horizontal coordinates show the wavelength of light.

FIG. 2 shows emission spectrum and excitation spectrum of embodiment 9, ordinates in the figure show luminous intensity, and horizontal coordinates show the wavelength of light.

FIG. 3 shows emission spectrum of the white LED prepared in embodiment 9, ordinates in the figure show luminous flux, and horizontal coordinates show the wavelength of light.

FIG. 4 shows emission spectrum of the white LED prepared in embodiment 3, ordinates in the figure show luminous flux, and horizontal coordinates show the wavelength of light.

FIG. 5 shows emission spectrum and excitation spectrum of embodiment 24, ordinates in the figure show luminous intensity, and horizontal coordinates show the wavelength of light.

FIG. 6 shows emission spectrum of the white LED produced by using another green fluorescent powder and by referencing the method of embodiment 24, ordinates in the figure show luminous flux, and horizontal coordinates show the wavelength of light.

### THE DETAILED METHOD AND BASIC PROCESSES

The Nitrogen Oxide luminescence material prepared by the method of the present invention can be excited by the light with excitation wavelength between 200-500 nm, and emits yellow or red light with wavelength between 500-750 nm. Accordingly, the chemical formula is as following: M_{1-y}A₄₋ₓZ₁₊ₓOₓN₇₋ₓ: R_{y}, M in the formula is for one or several of alkali metal, alkaline earth metal, rare earth metal and transition metals. X in the formula is for Si together with one or several of Si, Ge, B and Al. Z is for Al together with one or several of Al, Ga, In. R is for one or several of luminescence center elements Eu, Ce, Tb, Yb, Sm, Pr and Dy. And 0≦x<1.0, 0<y<1.0.

Preferably, M is for one or several of Li, Mg, Ca, Sr, Ba, Bi, Mn, Zn, La, Gd, Lu and Y.

Optimally, M is for Sr together with one or several of Li, Mg, Ca, Zn, Sr, Ba, Bi and Y.

The content of Sr is more than 0.8, and A is for Si, Z is for Al, R is for Eu, Ce or both.

Preferably, 0≦x≦0.15, 0≦y≦0.1.

Optimally, 0≦x≦0.1, 0.05≦y≦0.1.

### Embodiment 1

### The Preparation of the Luminescence Material Sr_{0.90}Li_{0.05}Si₄AlN₇:Ce_{0.05}

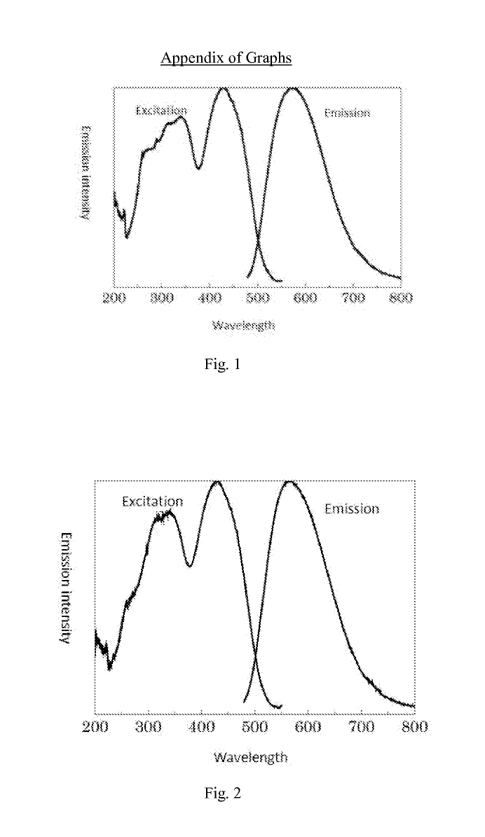

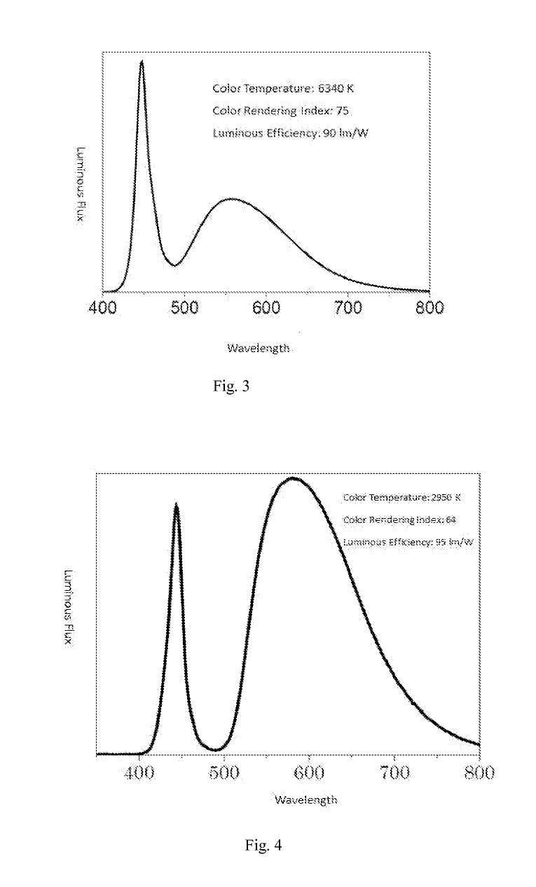

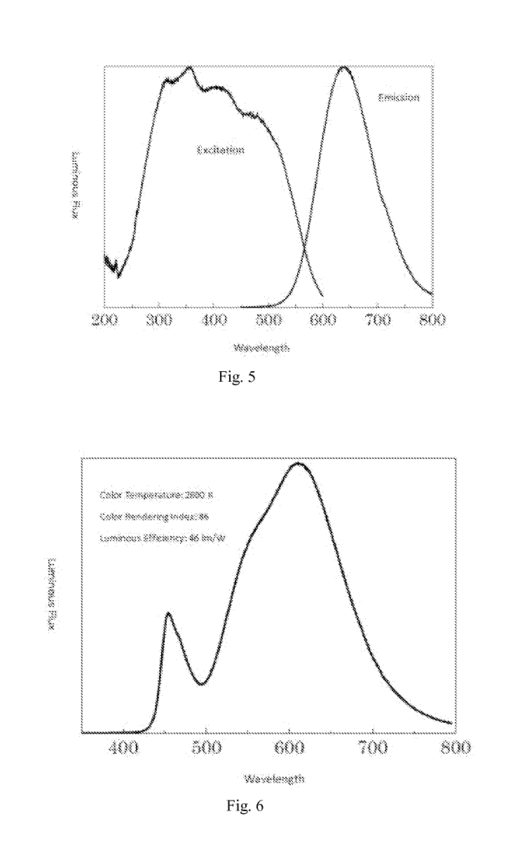

According to the components mentioned above, added respectively Sr₃N₂ (27.0746 g), Li₃N (0.1803 g), Si₃N₄ (57.6933 g), CeN (2.3798 g) and AlN (12.6719 g) into an argon-filled glove box, then after mixed and grinding evenly, filled into a Boron nitride crucible for roasting, under 0.3 MPa N₂, lasted for 4 hours at 1700° C. The reached powder, after grinding, needed under the same conditions to be roasted once more to promote grain growth. And then some luminescence material reached, after grinding, rinsing by hydrochloric acid, impurity removal and drying steps, eventually 100 g of the yellow luminescent materials reached, and emission spectrum and excitation spectrum of which see FIG. 1. In FIG. 1, we can see a wider emission spectrum range of the luminescence material, and the full width at half maximum (FWHM) is 130 nm, and the emission dominant peak is in the yellow region, at around 573 nm. And also we can see a wider excitation spectrum range, which is from the ultraviolet region to the visible region. Especially, the luminescence material can be excited simultaneously and effectively by ultraviolet light with wavelength between 300-420 nm, and by blue light 420-490 nm. And the corresponding luminous intensity sees table. 1. The luminous intensity values are all quite close to those from YAG:Ce in the embodiment control.

### Embodiment 9

### The Demonstration that the Preparation of the Luminescence Material Sr_{0.90}Li_{0.05}Si_{3.85}Al_{1.15}O_{0.15}N_{6.85}:Ce_{0.05}.

According to the components mentioned above, added respectively Sr₃N₂ (27.0204 g), Li₃N (0.1799 g), Si₃N₄ (55.4185 g), Ce₂O₃ (2.5293 g), Al₂O₃ (1.5731 g) and AlN (13.2788 g) into an argon-filled glove box, then after mixed and Fing evenly, filled into a Boron nitride crucible for roasting, under 0.3 MPa N₂, and with 0.1 g of SrF₂ as the fluxing agent, lasted for 4 hours at 1700° C. The reached powder, after grinding, needed under the same conditions to be roasted once more to promote grain growth. And then some luminescence material reached, after grinding, rinsing by hydrochloric acid, impurity removal and drying steps, eventually 100 g of the yellow luminescent materials reached, and emission spectrum and excitation spectrum of which see FIG. 2. In FIG. 2, we can see a wider emission spectrum range of the luminescence material, and the full width at half maximum (FWHM) is 132 nm, the main peaks of the emission spectrum is in the yellow region, at around 562 nm. And also we can see a wider excitation spectrum range, which is from the ultraviolet region to the visible region. Especially, the luminescence material can be excited simultaneously and effectively by ultraviolet light with wavelength between 300-420 nm, and by blue light 420-490 nm. And the corresponding luminous intensity sees table. 1. In contrast with embodiment 1, a blue-shift of the emission wavelength of the luminescence material was observed, which because of the oxygen introduced in the lattice mainly due to the weakening of the covalent bond, which improved the 5d orbital lowest energy level of Ce ion, and accordingly increased the energy of the emitted light, and shortened the emission wavelength. Although with the lower intensity comparing with that of YAG:Ce in the embodiment control, the luminescence material due to its shorter emission wavelength can be used to produce high color-temperature, high brightness white LED.

### Embodiment 2-8, 10-16

The preparation procedure from the embodiment above is the same as that from embodiment 1 or embodiment 9. The halide of Ce, such as CeCl₃ or the nitrate of Ce, such as Ce (NO₃)₃ can be used, and accordingly the reaction flux is chloride or fluoride of Sr, Ca, Ba, Li. And the corresponding luminous intensity of the luminescence material reached sees table. 1. The maximum emission wavelengths of these luminescence materials are in the yellow region and can be excited by blue and ultraviolet light, and be used to produce white LED replacing YAG fluorescent powder.

TABLE 1
The chemical formulae and characteristics of luminescence (the
excitation wavelength is 450nm) of embodiment 1-18.

| | | Emission | Rela- |
|---|---|---|---|
| | | Dominant | tive |
| Embodi- | | peak | Inten- |
| ment | Chemical Formulae | (nm) | sity |
| 1 | Sr_{0.90}Li_{0.05}Si₄AlN₇:Ce_{0.05} | 573 | 100 |
| 2 | Sr_{0.80}Li_{0.10}Si₄AlN₇:Ce_{0.10} | 576 | 94 |
| 3 | Sr_{0.85}Ca_{0.05} Li_{0.05}Si₄AlN₇:Ce_{0.05} | 580 | 85 |
| 4 | Sr_{0.85}Ba_{0.05} Li_{0.05}Si₄AlN₇:Ce_{0.05} | 568 | 93 |
| 5 | Sr_{0.80}Ba_{0.10} Li_{0.05}Si₄AlN₇:Ce_{0.05} | 565 | 90 |
| 6 | Sr_{0.80}Ca_{0.05}Ba_{0.05} Li_{0.05}Si₄AlN₇:Ce_{0.05} | 574 | 95 |
| 7 | Sr_{0.85}Zn_{0.05} Li_{0.05}Si₄AlN₇:Ce_{0.05} | 573 | 97 |
| 8 | Sr_{0.90}Li_{0.05}Si_{3.90}Al_{1.10}O_{0.10}N_{6.90}: | 567 | 101 |
| | Ce_{0.05} | | |
| 9 | Sr_{0.90}Li_{0.05}Si_{0.05}Al_{1.15}O_{0.15}N_{6.85}: | 562 | 84 |
| | Ce_{0.05} | | |
| 10 | Sr_{0.90}Li_{0.05}Si_{3.95}Ge_{0.05}AlN₇:Ce_{0.05} | 568 | 90 |
| 11 | Sr_{0.90}Li_{0.05}Si_{3.95}B_{0.05}AlN₇:Ce_{0.05} | 568 | 103 |
| 12 | Sr_{0.85}Ba_{0.05}Li_{0.05}Si_{3.95}B_{0.05}AlN₇: | 566 | 100 |
| | Ce_{0.05} | | |
| 13 | Sr_{0.90}Li_{0.05}Si₄Al_{0.95}Ga_{0.05}N₇:Ce_{0.05} | 569 | 83 |
| 14 | Sr_{0.85}Mg_{0.05}Li_{0.05}Si₄AlN₇:Ce_{0.05} | 574 | 90 |
| 15 | Sr_{0.80}Bi_{0.05}Li_{0.05}Si₄AlN₇:Ce_{0.05} | 576 | 98 |
| 16 | Sr_{0.80}Y_{0.05}Li_{0.10}Si₄AlN₇:Ce_{0.05} | 565 | 91 |
| Control | Y_{2.95}Al₅O₁₂: Ce_{0.05} | 557 | 110 |

TABLE 2
Optical parameters in the embodiments of the white LED

| | | Chromaticity | Color | | |
|---|---|---|---|---|---|
| | | Coordinate | Rendering | Color | Luminous |
| White LED | Embodiment | (x, y) | Index | Temperature/K. | Efficiency |
| Blue LED + | Embodiment 17 | (0.3172, 0.3173) | 75 | 6340 | 90 |
| Embodiment 9 | | | | | |
| Blue LED + | Embodiment 18 | (0.4332, 0.3912) | 64 | 2950 | 95 |
| Embodiment 3 | | | | | |

### Embodiment 17

### The Preparation of White LED Electric Light Source

Weighed a certain amount of fluorescent powder produced according to embodiment 9, and uniformly dispersed in the epoxy resin, then after mixed and de-aeration step, the compound reached was coated on a commercially available blue LED chip, and the emission wavelength of the blue LED is 450 nm. Eventually, after drying for 0.5 hour at 150° C., encapsulation step finished. Blue light emitted by blue LED mixed with yellow and red light emitted by fluorescent powder, produced cool white light with coordinates as following: x=0.3172, y=0.3173, and with color rendering index: Ra=75, and with color temperature: T=6340K.

### Embodiment 18

### The Preparation of White LED Electric Light Source

Weighed a certain amount of fluorescent powder produced according to embodiment 3, and uniformly dispersed in the epoxy resin, then after mixed and de-aeration step, the compound reached was coated on a commercially available blue LED chip, and the emission wavelength of the blue LED is 450 nm. Eventually, after drying for 0.5 hour at 150° C., encapsulation step finished. Blue light emitted by blue LED mixed with yellow and red light emitted by fluorescent powder, produced cool white light with coordinates as following: x=0.4332, y=0.3912, and with color rendering index: Ra=64, and with color temperature: T=2950K.

TABLE 3
The chemical formulae and characteristics of luminescence (the excitation
wavelength is 450 nm) of embodiment 19-31.

| | | Emission | |
|---|---|---|---|
| | | Dominant | Relative |
| Embodiment | Chemical Formulae | peak (nm) | Intensity |
| 19 | Sr_{0.95}Si₄AlN₇:Eu_{0.05} | 630 | 100 |
| 20 | Sr_{0.9}Si₄AlN₇:Eu_{0.10} | 638 | 96 |
| 21 | Sr_{0.90}Ca_{0.05}Si₄AlN₇:Eu_{0.05} | 623 | 110 |
| 22 | Sr_{0.90}Ba_{0.05}Si₄AlN₇:Eu_{0.05} | 632 | 103 |
| 23 | Sr_{0.90}Ba_{0.05}Ca_{0.05}Si₄AlN₇:Eu_{0.05} | 627 | 105 |
| 24 | Sr_{0.90}Li_{0.1}Si₄AlN₇:Eu_{0.05} | 634 | 121 |
| 25 | Sr_{0.90}Y_{0.033} Si₄AlN₇:Eu_{0.05} | 631 | 91 |
| 26 | Sr_{0.90}Li_{0.1}Si_{3.95}Al_{1.05}O_{0.05}N_{6.95}: | 630 | 107 |
| | Eu_{0.05} | | |
| 27 | Sr_{0.95}Si_{3.95}Al_{1.05}O_{0.05}N_{6.95}:Eu_{0.05} | 628 | 97 |
| 28 | Sr_{0.95}Si_{3.90}Al_{1.10}O_{0.10}N_{6.90}:Eu_{0.05} | 625 | 93 |
| 29 | Sr_{0.85}Ba_{0.10}Si_{3.95}Al_{1.05}O_{0.05}N_{6.95}: | 621 | 91 |
| | Eu_{0.05} | | |
| 30 | Sr_{0.90}Si_{3.95}Ge_{0.05}AlN₇:Eu_{0.05} | 626 | 93 |
| 31 | Sr_{0.90}Mg_{0.1}Si₄AlN₇:Eu_{0.05} | 627 | 97 |

### Embodiment 26

### The Preparation of the Luminescence Material Sr_{0.90}Li_{0.1}Si_{3.95}Al_{1.05}O_{0.05}N_{6.95}:Eu_{0.05}

According to the components mentioned above, added respectively Sr₃N₂ (26.9283 g), Li₃N (0.3586 g), Si₃N₄ (56.6642 g), Eu₂O₃ (2.7128 g), Al₂O₃ (0.5226 g) and AlN (12.8135 g) into an argon-filled glove box, then after mixed and grinding evenly, filled into a Boron nitride crucible for roasting, under 0.5 MPa N₂, and with 0.1 g of SrF₂ as the fluxing agent, lasted for 4 hours at 1700° C. The reached powder, after grinding, needed under the same conditions to be roasted once more to promote grain growth. And then some luminescence material reached, after grinding, rinsing by hydrochloric acid, impurity removal and drying steps, eventually 100 g of the red luminescent materials reached, and emission spectrum and excitation spectrum of which see FIG. 2. In FIG. 2, we can see a wider emission spectrum range of the luminescence material, and the full width at half maximum (FWHM) is 133 nm, and the emission dominant peak is in the yellow region, at around 630 nm. And also we can see a wider excitation spectrum range, which is from the ultraviolet region to the visible region. Especially, the luminescence material can be excited simultaneously and effectively by ultraviolet light with wavelength between 300-420 nm, and by blue light 420-490 nm. And the corresponding luminous intensity sees table 3. The wider emission spectrum range is due to Eu²⁺ luminescence, not the Eu³⁺ spectrum luminescence, which illustrates that in the furnace atmosphere, Eu³⁺ in the raw materials was reduced to Eu²⁺ during high-temperature reaction. In contrast with embodiment 19, a blue-shift of the emission wavelength of the luminescence material was observed, which because of the oxygen introduced in the lattice mainly due to the weakening of the covalent bond, which improved the 5d orbital lowest energy level of Ce ion, and accordingly increased the energy of the emitted light, and shortened the emission wavelength.

### Embodiment 19-25, 27-31

The preparation procedure from the embodiment above is the same as that from embodiment 26. The nitride of Eu such as EuN or the halide of Eu, such as EuCl₂ or the nitrate of Eu, such as Eu(NO₃)₃ can be used, and accordingly the reaction flux is chloride or fluoride of Sr, Ca, Ba, Li. And the corresponding luminous intensity of the luminescence material reached sees table. 3. The maximum emission wavelengths of these luminescence materials are in the red region and can be excited by blue and ultraviolet light, and therefore, in combination with blue or ultraviolet LED chip, can be used to produce white LED with high color rendering index.

TABLE 4
Optical parameters in the embodiments of the white LED

| | | Chromaticity | Color | | |
|---|---|---|---|---|---|
| | | Coordinate | Rendering | Color | Luminous |
| White LED | Embodiment | (x, y) | Index | Temperature/K. | Efficiency |
| Blue LED + Embodiment | Embodiment | (0.4632, | 86 | 2800 | 46 |
| 24 + blue Sr₂SiO₄: Eu²⁺ | 32 | 0.4184) | | | |
| fluorescent powder | | | | | |

### Embodiment 32

### The Preparation of White LED Electric Light Source which has High Color Rendering Index

Weighed a certain amount of red fluorescent powder produced according to embodiment 26, and a certain amount of silicate Sr₂SiO₄: Eu²⁺ fluorescent powder (other green fluorescent powders such as SrSi₂O₂N₂: Eu²⁺ or β-sialon:Eu²⁺ are also available), then uniformly dispersed in the epoxy resin, and after mixed and de-aeration step, the compound reached was coated on a commercially available blue LED chip, and the emission wavelength of the blue LED is 450 nm. Eventually, after drying for 0.5 hour at 150° C., encapsulation step finished. Blue light emitted by blue LED mixed with red and green light emitted by fluorescent powder, produced warm white light with coordinates as following: x=0.4632, y=0.4184, and with color rendering index: Ra=86, and with color temperature: T=2800K.

The above-described embodiments aimed at helping the skilled artisans better understanding the present invention. And it should be pointed out that, in addition to the limitations of the appending claims of the present invention, the present invention is not limited to the specific embodiments described in the specification.

1. A nitrogen oxide luminescence material, with the chemical formula: M_{1-y}A₄₋ₓZ₁₊ₓOₓN₇₋ₓ: R_{y}, wherein:
M represents one or several of alkali metals, alkaline earth metals, rare earth metals and transition metals;
A represents Si together with one or several of Si, Ge, B and Al;
Z represents Al together with one or several of Al, Ga, In;
R represents one or several of luminescence center elements Eu, Ce, Tb, Yb, Sm, Pr and Dy;
0≦x<0.5,0<y<1.0.

2. The nitrogen oxide luminescence material according to claim 1, wherein:
M represents one or several of Li, Mg, Ca, Sr, Ba, Bi, Mn, Zn, La, Gd, Lu and Y.

3. The nitrogen oxide luminescence material according to claim 2, wherein:
M represents Sr together with one or several of Li, Mg, Ca, Sr, Ba, Bi, Zn and Y.

4. The nitrogen oxide luminescence material according to claim 3, wherein:
the content of Sr is more than 0.8,
A represents Si,
Z represents Al, and
R represents Eu, Ce or both.

5. The nitrogen oxide luminescence material according to claim 1, wherein:
0≦x≦0.15, and
0<y≦0.1.

6. The nitrogen oxide luminescence material according to claim 5, wherein:
0≦x≦0.1, and
0.05≦y≦0.1.

7. A method of preparing the nitrogen oxide luminescence material of claim 1, comprising:
(1) by milling, obtaining a mixture by mixing M-containing oxides, nitrides, nitrates or carbonates with X-containing nitrides or oxides with Z-containing nitrides or oxides, and with R-containing nitrides, oxides or nitrates;
(2) under inert gas protection heating the mixture using gas pressure sintering or a solid reaction process to obtain a reacted product; and
(3) applying to the reacted product a process including grinding, impurity removal, heating and sizing, to obtain the nitrogen oxide luminescence material.

8. The method according to claim 7, wherein:
the inert gas in the gas pressure sintering step includes nitrogen, with the pressure between 1-200 atmospheres;
the inert gas in the solid reaction process includes a mixture of nitrogen and hydrogen at substantially standard pressure, with a volume ratio in a range from 95:5 to 80:20; and
a gas flow rate is between 0.1-3 L/min.

9. The method according to claim 7, wherein:
heating the mixture includes heating the mixture in an environment having a temperature in a range from 1,200° C. to 1,800° C. for 0.5-30 hours either once or several times.

10. The method according to claim 9, wherein:
heating the mixture includes performing carbon thermal reduction nitridation in an environment having a temperature in a range from 1,200° C. to 1,800° C.

11. The method according to claim 7, further comprising:
adding to the mixture a reaction flux, the reaction flux including an M-containing halide, or boric acid, or both.

12. The method according to claim 11, wherein:
the amount of the reaction flux is 0.01-10% of the total amount of the other materials in the mixture.

13. The method according to claim 7, wherein:
the impurity removal includes acid pickling or rinsing by water.

14. A white LED light source comprising:
at least one of:
an ultraviolet LED;
a near ultraviolet LED; and
a blue LED; and
the nitrogen oxide luminescence material according to claim 1.

15. The white LED according to claim 14, wherein:
M represents one or several of Li, Mg, Ca, Sr, Ba, Bi, Mn, Zn, La, Gd, Lu and Y.

16. The white LED according to claim 15, wherein:
M represents Sr together with one or several of Li, Mg, Ca, Sr, Ba, Bi, Zn and Y.

17. The white LED according to claim 16, wherein:
the content of Sr is more than 0.8,
A represents Si,
Z represents Al, and
R represents Eu, Ce or both.

18. The white LED according to claim 14, wherein:
0≦x≦0.15, and
0<y≦0.1.

19. The white LED according to claim 18, wherein:
0≦x≦0.1, and
0.05≦y≦0.1.
